(19) United States
(12) Patent Application Publication
(10) Pub. No.: US 2011/0220084 A1
(43) Pub. Date: Sep. 15, 2011

(54) METHOD FOR OPERATING AN INTERNAL COMBUSTION ENGINE

(75) Inventors: Ingmar Burak, Stuttgart (DE); Klaus Winkler, Rutesheim (DE)

(73) Assignee: ROBERT BOSCH GMBH, Stuttgart (DE)

(21) Appl. No.: 13/040,371

(22) Filed: Mar. 4, 2011

(30) Foreign Application Priority Data
Mar. 4, 2010 (DE) 10 2010 002 586.0

(51) Int. Cl. F02D 41/30; F02D 28/00; F01N 3/10

(52) U.S. Cl. 123/703; 701/104

(57) ABSTRACT

A method for operating an internal combustion engine (10) for a motor vehicle, said internal combustion engine (10) comprising an exhaust gas system (26) having at least one catalytic converter (28; 30) and at least one lambda probe (38; 40). The internal combustion engine (10) is operated alternately with a lean and a rich fuel-air mixture after a cold start for heating the catalytic converter (28; 30). The lambda probe (40) is heated after the cold start in such a way that it is ready for operation after at most 10 s and the internal combustion engine (10) is operated with a two-level control based on a signal (U_{L}) from the lambda probe (40), such that the change between the operation with lean fuel-air mixture and the operation with rich fuel-air mixture is in each case initiated by the signal (U_{L}) from the lambda probe (40).

### RELATED APPLICATION

The present application claims priority to German Patent Application No. 102010002586.0, filed on Mar. 4, 2010, the entire content of which is hereby incorporated by reference.

### BACKGROUND OF THE INVENTION

The present invention relates to a method for operating an internal combustion engine for a motor vehicle and to an open-loop and/or closed-loop controlling means, a computer program and a computer program product.

In order to meet the strict exhaust gas standards in internal combustion engines, it is necessary to heat a catalytic converter as quickly as possible to an operating temperature at which it can convert pollutants to an adequate extent. According to a conventional definition, a temperature at which 50% of the pollutant emissions occurring upstream of the catalytic converter, such as carbon monoxide (CO), hydrocarbons (HC) and nitrogen oxides (NOₓ), are converted into harmless exhaust gas components is referred to as light-off temperature.

For heating the catalytic converter, various measures are known, such as, for example, an increase in the exhaust gas temperature by increased air feed into a combustion chamber of the internal combustion engine and subsequent retarded ignition, a mixture enrichment in conjunction with secondary air injection, use of a glow plug in the exhaust gas system upstream of the catalytic converter, etc.

With regard to the conversion of pollutant components, a storage capacity of the catalytic converter for oxygen is especially important. The storage capacity for oxygen is used in order to absorb oxygen during lean phases and deliver oxygen again during rich phases. This ensures that the pollutant components of the exhaust gas that are to be oxidized can be converted into harmless components. The conversion reaction takes place exothermally.

DE 10 2006 014 249 A1 shows a method for the pilot control of a lambda value during a heating phase of an exhaust gas system of an internal combustion engine having a catalytic converter and at least one lambda probe, the lambda probes being arranged upstream of and/or downstream of the catalytic converter. In this case, at a lambda probe which is still not ready for operation, a lambda time characteristic of a lambda pilot control is controlled during the heating phase of the catalytic converter at least partly by means of a higher-frequency modulation in such a way that an average lambda time value >1 (lean mixture) is preset during this phase and a lambda value of <1 (rich mixture) is also achieved at least briefly. As a result of this specific control strategy for the lambda, partial conversion of the nitrogen oxides is already achieved during this phase, since a lambda value of <1 is at least temporarily achieved. At the same time, the conversion of the components to be oxidized, such as HC and CO, is not adversely affected by the continuing average lean lambda value. This modulation is maintained until a first lambda probe is ready for operation. After that, a changeover to the known closed-loop lambda control is effected and the catalytic converter is heated further via this method. The operational readiness of the lambda probe is not achieved until a very late stage, since the probe likewise requires a certain operating temperature and is only heated when the exhaust gas is so hot that it no longer contains any condensed water in liquid form. For a lambda probe arranged downstream of a catalytic converter, the operational readiness is often not achieved until after more than a minute.

### SUMMARY OF THE INVENTION

The present invention differs from the prior art mentioned at the beginning in that the lambda probe is heated after the cold start in such a way that it is ready for operation after at most 10 s and the internal combustion engine is operated with a two-level control based on a signal from the lambda probe, such that the change between the operation with lean fuel-air mixture and the operation with rich fuel-air mixture is in each case initiated by the signal from the lambda probe.

Compared with a controlled modulation, the invention has the advantage that the lambda value required on average with respect to time for the conversion of nitrogen oxides, hydrocarbons and carbon monoxide can be maintained more accurately. The control oscillation which occurs during the two-level control additionally leads to exothermal reactions which take place directly on the catalytic converter surface and therefore contribute to effective and rapid heating. The heating effect can be better optimized by the closed-loop control rather than by the open-loop control.

In a preferred configuration, the two-level control is based on the signal from a lambda probe arranged downstream of the catalytic converter. As a result, the respective, current, temperature-dependent oxygen storage capacity can be optimally utilized without inadmissibly high HC concentrations occurring downstream of the catalytic converter.

### BRIEF DESCRIPTION OF THE DRAWINGS

Further advantages follow from the description below and the attached figures.

It goes without saying that the abovementioned features and the features still to be explained below can be used not only in the respectively specified combinations but rather also in other combinations or on their own without departing from the scope of the invention.

An exemplary embodiment of the invention is shown in the figures and is described in more detail below. In the figures, in each case in schematic form:

FIG. 1 shows the environment of the invention;

FIG. 2 shows an output signal from a binary lambda probe in a simplified illustration;

FIG. 3 shows a control factor determined on the basis of the signal in FIG. 2;

FIG. 4 shows characteristics of the signal from a lambda probe and a control factor FR resulting therefrom and an associated speed characteristic; and

FIG. 5 shows characteristics of further physical variables correlated with respect to time with the characteristics shown in FIG. 4.

### DETAILED DESCRIPTION

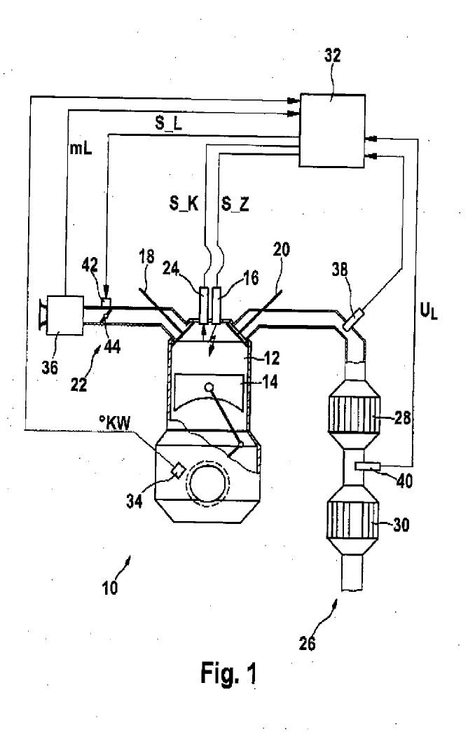

FIG. 1 shows an internal combustion engine 10 having at least one combustion chamber 12 which is sealed in a movable manner by a piston 14. Charges in the combustion chamber 12 with a mixture of fuel and air are ignited by a spark plug 16 and burned. An exchange of the charge in the combustion chamber 12 is controlled by gas exchange valves 18 and 20, which are opened and closed in phase synchronization with the movement of the piston 14. The various possibilities for actuating the gas exchange valves 18 and 20 are familiar to the person skilled in the art and are not shown in detail in FIG. 1 for the sake of clarity. When inlet valve 18 is open and piston 14 is moving downward, that is to say during the induction stroke, air flows from an induction system 22 into the combustion chamber 12. Fuel is added to the air in a metered fashion in the combustion chamber 12 via an injector 24. When exhaust valve 20 is open, an exhaust gas mass flow resulting from the combustion of the charges in the combustion chamber is discharged into an exhaust gas system 26 which has at least one 3-way catalytic converter 28. In general, the exhaust gas system 26 will contain a plurality of catalytic converters, for example a pre-catalytic converter 28 fitted close to the engine and a main catalytic converter 30 which is fitted in a position further from the engine and which can be, for example, a 3-way catalytic converter or a NOx storage catalytic converter.

The internal combustion engine 10 is controlled by an open-loop and/or closed-loop controlling means which is designed as control unit 32 and which processes, for this purpose, signals from various sensors in which operating parameters of the internal combustion engine 10 are reproduced. In the non-exclusive illustration in FIG. 1, said sensors are a rotation angle sensor 34 which detects an angular position ° KW of a crankshaft of the internal combustion engine 10 and thus a position of the piston 14, an air flow sensor 36 which detects an air mass mL flowing into the internal combustion engine 10, a first lambda probe 38 which is arranged upstream of the 3-way catalytic converter 28, and a second lambda probe 40 which is arranged downstream of the 3-way catalytic converter 28. The signal provided by the lambda probe 40 is designated by U_{L}.

The lambda probes 38, 40 detect an oxygen concentration in the exhaust gas as a measure of an air coefficient lambda. It is known that lambda is defined as the quotient of an actually available air mass in the numerator and an air mass in the denominator that is required for a stoichiometric combustion of a specific fuel mass. Air coefficients of lambda >1 therefore represent excess air (lean mixture), whereas air coefficients of lambda <1 represent excess fuel (rich mixture).

From the signals of these and possibly further sensors, or probes, the control unit 32 forms actuating signals for activating the internal combustion engine 10. In the configuration in FIG. 1, these are, in particular, an actuating signal S_L for activating a throttle valve positioner 42 which adjusts the angular position of a throttle valve 44 in the induction system 22, a signal S_K with which the control unit 32 activates the injector 24, and an actuating signal S_Z with which the control unit 32 activates the spark plug 16 or an ignition device 16, which also has coils and/or capacitors for generating an ignition voltage. In a similar manner to the illustration of the sensors, it is also the case for the actuators shown that the illustration in FIG. 1 is not meant to be exclusive and that modern internal combustion engines 10 can have other actuators such as exhaust gas recycling valves, tank venting valves, bypass valves for an exhaust turbocharger, actuators for variable controls of the gas exchange valves 18, 20, etc.

Apart from that, the control unit 32 is set up, in particular programmed, for carrying out the method presented here, with the configurations thereof, and for controlling a corresponding method sequence.

In a preferred configuration, the control unit 32 is set up by loading a computer program having the features of the independent computer program claim from a computer program product having the features of the independent computer program product claim. In this respect, the expression “computer program product” refers to any data set or collection of data sets which the computer program contains in a stored form and also to any carrier which contains such a data set or collection of data sets.

In normal operation of the internal combustion engine, with catalytic converter at operating temperature, the control unit 32 carries out a closed-loop lambda control on the basis of the signal from the front lambda probe 38, which on account of the arrangement thereof upstream of the catalytic converter 28 reacts comparatively quickly to changes in the mixture composition and which can help to achieve a high accuracy of the rear lambda probe 40. On account of the arrangement thereof downstream of the catalytic converter 28, the rear lambda probe 40 provides an especially accurate signal, with which the set point for the closed-loop control with the front lambda probe 38 is corrected, for example, in normal operation.

In particular the lambda probe 40 arranged downstream of the 3-way catalytic converter 28 is preferably designed as a binary lambda probe (discrete-level sensor). This means that, in operation, depending on the oxygen concentration in the exhaust gas, it generates essentially only two signal values, which represent a lambda value of >1 or a lambda value of <1.

Due to the design, the binary lambda probe 40 generates a low signal value if a lean mixture (excess oxygen) is detected and a high signal value if a rich mixture (lack of oxygen) is detected. In the very narrow region of lambda=1, the signal changes more or less suddenly in the process.

The invention is based on the use of a lambda probe 40 which is not sensitive to condensed water droplets in the exhaust gas and can therefore even be heated before, during or very quickly after a start of the internal combustion engine and is thus ready for operation in less than 10 seconds after a start. Such insensitivity can be achieved, for example, by protective tubes of metal with apertures oriented in the direction of flow of the exhaust gas and/or by a coating which protects the probe ceramic.

In contrast, conventional lambda probes can be damaged by a thermal shock in the operationally ready state, such thermal shock being caused by condensed water droplets striking the probe ceramic. The conventional probes are therefore not electrically heated until the exhaust gas system as a whole is so hot that liquid condensed water no longer occurs. This can take more than a minute in the case of a lambda probe arranged downstream of a catalytic converter.

The invention is characterized in this technical environment by the fact that the lambda probe 40 is heated after the cold start in such a way that it is ready for operation after at most 10 s and the internal combustion engine 10 is operated with a two-level control. In this case, it is especially preferred that the two-level control is based on the signal U_{L} from the rear lambda probe 40, such that the change between the operation with lean fuel-air mixture and the operation with rich fuel-air mixture is in each case initiated by the signal U_{L} from the lambda probe 40.

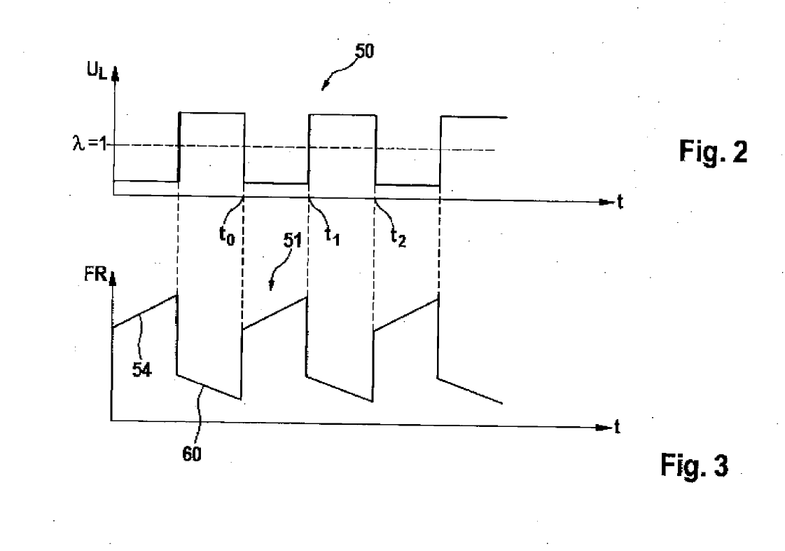

The two-level control is explained below with reference to FIGS. 2 and 3. In the two-level lambda control, the signal U_{L} is compared in the control unit 32 with a threshold value which separates probe signal values representing rich mixture from probe signal values representing lean mixture. The result is a signal characteristic 50, as depicted in FIG. 2. The signal characteristic 50 therefore corresponds to the result of said comparison. In a first time interval which extends from t0 to t1, the lambda probe 40 records a lean mixture. In the configuration shown, this leads to a low level in the signal 50, which represents the result of the threshold value comparison. In the subsequent interval from t1 to t2, the lambda probe 40 records a rich mixture, which is reflected in a high level of the signal 50.

FIG. 3 shows a corresponding characteristic 51 of a manipulated variable FR. In this case, the manipulated variable FR has a multiplicative effect on injection pulse widths, with which the injectors 24 are actuated by the control unit 32.

At the time t0, the lambda probe 40 records a transition from rich mixture to lean mixture. After that, the manipulated variable FR is first increased suddenly and is then further increased with an integrator ramp in a ramp form with a predetermined slope. The increase is effected until a change in the mixture composition from lean to rich is recorded by the lambda probe 40 at the time t1. This is followed by a sudden adjustment of FR to lower values and a ramp which runs with a negative slope until time t2, at which instant the lambda probe 40 records a further change in the mixture composition.

This process is repeated periodically at a frequency which is specific to the controlled system and which depends essentially on the dead time of the controlled system and which, in an internal combustion engine, results as the sum of all the times which lie between the fuel metering influenced by the control factor and the reproduction of this effect in the signal from the lambda probe 40. This sum comprises the times during which the resulting fuel-air mixture is compressed, burned and discharged in the internal combustion engine, the delay which results from the charging and/or discharging of the oxygen reservoir of the catalytic converter 28, the exhaust gas running time up to the catalytic converter 28 and from the catalytic converter 28 up to the lambda probe 40, and the response time of the lambda probe 40. This frequency is also referred to below as the natural frequency of the closed-loop control and the closed-loop control is correspondingly referred to as natural frequency control.

Due to the resulting control oscillation during which the lambda actual value fluctuates about the average lambda value 1, exhaust gas volumes alternately acting in a reducing and oxidizing manner are input into the catalytic converter, and these exhaust gas volumes lead to exothermal reactions on account of the oxygen storage effect of the catalytic converter. These exothermal reactions heat the 3-way catalytic converter 28, such that this leads to an increase in the catalytic converter temperature relative to the exhaust gas temperature upstream of the 3-way catalytic converter 28. In the process, the oxygen storage capacity of the catalytic converter, which storage capacity depends on the temperature of the catalytic converter prevailing at that moment, is fully utilized for generating exothermal reaction heat. This advantage results as a direct consequence of the fact that the signal U_{L} from the lambda probe 40 arranged downstream of the catalytic converter 28 serves as input signal of the natural frequency control.

As an alternative to the natural frequency control on the basis of the signal from the rear lambda probe 40, the two-level control can also be effected on the basis of the signal from the front lambda probe 38. However, the advantage of the optimum utilization of the oxygen storage capacity of the catalytic converter 28 is then dispensed with.

The natural frequency control is preferably ended when the 3-way catalytic converter 28 has reached its “light-off temperature”. The associated instant is preferably determined by a temperature model which integrates, for example, the fuel and/or air mass metered since a start. A threshold value with which the value of the integral can be compared is assigned to the light-off temperature.

After the light-off temperature is reached, a changeover can be effected from the natural frequency control, which is based on the signal U_{L} from the rear lambda probe 40, to a conventional two-level control, which is based on the signal from the front lambda probe 38.

In a preferred configuration, the method according to the invention is combined with a further measure for the accelerated heating of the catalytic converter. In this case, the internal combustion engine is preferably operated within the scope of the further measure at a reduced efficiency and with an increased charge in the combustion chamber. Due to the reduced efficiency, a desirably increased exhaust gas temperature is obtained on account of thermodynamic laws. The loss of torque accompanying the lower efficiency is compensated for by the increased charge in the combustion chamber, which brings about the additional advantage of an increased value of the exhaust gas mass flow. The increased exhaust gas mass flow, in conjunction with the natural frequency control according to the invention, exhibits the additional advantage of an increase in this natural frequency, a factor which additionally increases the quantity of the exothermally generated reaction heat in the catalytic converter and thus helps to further accelerate the heating of the catalytic converter. The reduction in the efficiency is preferably achieved with a controlled retardation of the ignition angle. The increased charge in the combustion chamber is preferably achieved by wide opening of the throttle valve.

In practical terms, therefore, the exhaust gas system 26 and in particular the lambda probe 40 are immediately heated before and/or during and/or directly after an engine start (cold start), such that said lambda probe 40 is ready for operation in a time of less than 10 s. In addition, measures for rapidly heating the exhaust gas system 26 with an increased charge in the combustion chamber and reduced efficiency are initiated by the control unit 32 at the same time.

In a preferred configuration, the measure for rapidly heating the exhaust gas system 26 is further intensified by a first portion of the fuel quantity being injected during the induction stroke and at least one second portion of the fuel quantity being injected during the compression stroke. The split injection results in a homogeneous, but comparatively lean, distribution of the fuel quantity injected first in the combustion chamber together with a zone, resulting from the injection of the second portion, having a comparatively rich and therefore readily ignitable fuel-air mixture in the vicinity of a spark plug. This operation of the internal combustion engine is also referred to as homogenous split operation and is possible in internal combustion engines having direct gasoline injection.

The homogeneous split operation permits a very late ignition point in the region of 10-30° crankshaft angle after ignition TDC (TDC=top dead center) with stable speed behavior and controllable untreated emissions. The late ignition point leads to a comparatively poor ignition angle efficiency, which is understood here as the ratio of the torques at the late ignition point and an optimum ignition point for the torque development. The torque loss resulting from the poor ignition angle efficiency is compensated for by an increase in the charges in the combustion chamber of the internal combustion engine. The specified ignition angle values result in increases in the charges in the combustion chamber up to values which are about 75% of the maximum charge that is possible under standard conditions. This results overall in a comparatively large exhaust gas mass flow, the temperature of which, on account of the poor ignition angle efficiency, is comparatively high, and so a maximum heat flow (enthalpy flow) occurs in the exhaust gas system.

At the instant at which the lambda probe 40 is ready for operation, the 3-way catalytic converter 28, at least at the catalytic converter inlet, has also already reached a certain temperature, such that, within certain limits, it can store oxygen from a lean exhaust gas mass flow or deliver oxygen to a rich exhaust gas mass flow for oxidation.

If the lambda probe 40 is ready for operation even before the catalytic converter reaches such a temperature, in a preferred configuration a closed-loop control based on the signal from this lambda probe 40 is started directly. As a result, possible mismatching of base values of the injection pulse widths can already be corrected at a very early stage, which reduces the untreated pollutant emissions of the internal combustion engine, that is to say the pollutant emissions which occur in the exhaust gas before exhaust gas aftertreatment.

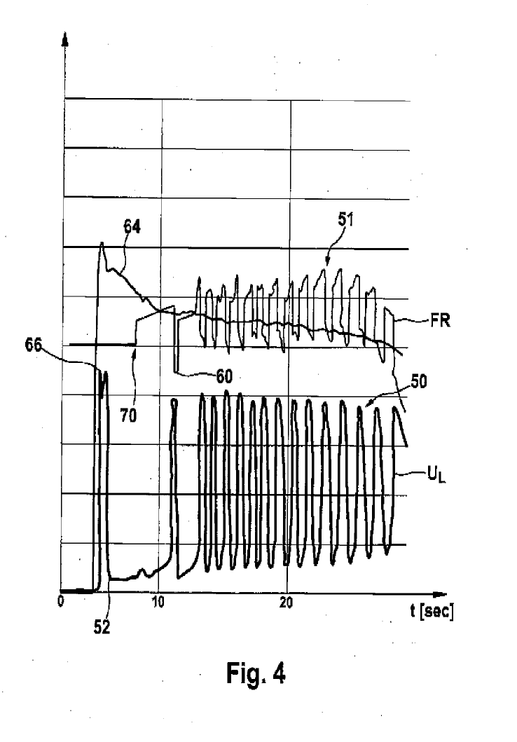

FIG. 4 shows a characteristic 50 of the signal U_{L} from the rear lambda probe 40, an associated characteristic 51 of the control factor FR resulting therefrom, and an associated characteristic 64 of an engine speed.

The start is approximately at the time t=3 s with a run-up, starter-assisted as a rule, of the internal combustion engine 10. The lambda probe 40 is already ready for operation at the time t=approx. 4 s and delivers a first high signal valve U_{L} (cf. reference numeral 66) which is still not evaluated by the two-level control. At the time t=approx. 5 s, the lambda probe 40 delivers a signal U_{L} having a low level (cf. reference numeral 52). This means that the lambda probe 40 detects a lambda value >1, that is to say excess air. The two-level control is not activated in the control unit 32 (cf. reference numeral 70). The method described with the aid of the schematic illustrations in FIGS. 2 and 3 now takes place. In the process, the frequency at the start is high to begin with—due to the oxygen storage reservoir, which is still small on account of the temperature, of the 3-way catalytic converter 28.

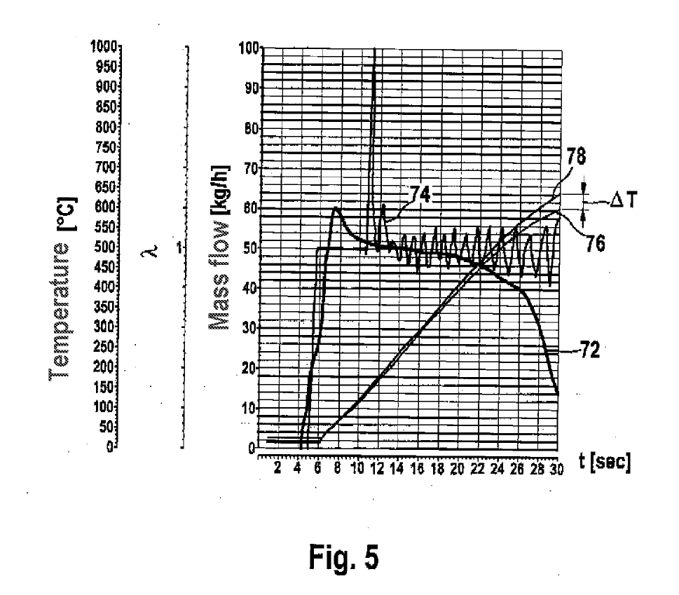

FIG. 5 shows characteristics of further physical variables correlated with respect to time with the characteristics shown in FIG. 4. Thus, a characteristic of the exhaust gas mass flow 72, a characteristic of the air coefficient lambda 74 and two characteristics 76 and 78 of a temperature of the 3-way catalytic converter 28 are shown. The characteristic 76 shows a temperature profile of the 3-way catalytic converter 28 when using only the homogeneous split operation for heating the catalytic converter; the characteristic 78 shows a temperature profile of the 3-way catalytic converter 28 when using the homogeneous split operation including the natural frequency control according to the invention for heating the catalytic converter. FIG. 5 shows that, when the natural frequency control is used, an additional increase in the catalytic converter temperature ΔT of about 40° C. occurs at the time t=approx. 30 s. At this instant, the exhaust gas mass flow is reduced by about 75%. The additional increase in the catalytic converter temperature ΔT is advantageous in particular against the background of maintaining stricter legal emission limit values, since the 3-way catalytic converter 28 reaches its light-off temperature quicker due to this measure and is therefore ready for operation earlier.

1. A method for operating an internal combustion engine (10) for a motor vehicle, said internal combustion engine (10) comprising an exhaust gas system (26) having at least one catalytic converter (28; 30) and at least one lambda probe (38; 40), wherein the internal combustion engine (10) is operated alternately with a lean and a rich fuel-air mixture after a cold start for heating the catalytic converter (28; 30), the method comprising:
heating the lambda probe (40) after the cold start in such a way that it is ready for operation after at most 10 s; and
operating the internal combustion engine (10) with a two-level control based on a signal (U_{L}) from the lambda probe (40), such that the change between the operation with lean fuel-air mixture and the operation with rich fuel-air mixture is in each case initiated by the signal (U_{L}) from the lambda probe (40).

2. A method according to claim 1, characterized in that the change is initiated by the signal (U_{L}) from the lambda probe (40) which is arranged downstream of the catalytic converter (28).

3. A method according to claim 1, characterized in that the change is initiated by a signal from the lambda probe (38) which is arranged upstream of the catalytic converter (28).

4. A method according to claim 1, further comprising opening a throttle valve (44) of the internal combustion engine (10) wide during the heating of the catalytic converter (28), and retarding an ignition angle of the internal combustion engine (10).

5. A method according to claim 1, further comprising operating the internal combustion engine (10), during the heating of the catalytic converter (28), with a homogeneous fuel-air mixture and with a plurality of partial injections repeatedly per operating cycle into a combustion chamber (12) of the internal combustion engine (10).

6. A system operating an internal combustion engine (10) for a motor vehicle, said system comprising:
an exhaust gas system (26) having at least one catalytic converter (28; 30);
at least one lambda probe (38; 40); and
a controller (32) configured to operate the internal combustion engine (10) alternately with a lean and a rich fuel-air mixture after a cold start for heating the catalytic converter (28; 30), to heat the lambda probe (40) after the cold start in such a way that it is ready for operation after at most 10 seconds, and operating the internal combustion engine (10) with a two-level control based on a signal (U_{L}) from the lambda probe (40), such that the change between the operation with lean fuel-air mixture and the operation with rich fuel-air mixture is in each case initiated by the signal (U_{L}) from the lambda probe (40).

7. The system of claim 6, wherein the controller (32) is an open-loop controller.

8. The system of claim 6, wherein the controller (32) is a closed-loop controller.

9. The system according to claim 6, wherein the controller (32) operates as both an open-loop controller and a closed-loop controller.

10. The system according to claim 6, wherein the change is initiated by a signal (U_{L}) from a lambda probe (40) which is arranged downstream of the catalytic converter (28).

11. The system according to claim 6, wherein the change is initiated by a signal from the lambda probe (38) which is arranged upstream of the catalytic converter (28).

12. The system according to claim 6, further comprising a throttle valve (44), wherein the throttle valve (44) is opened wide, and an ignition angle of the internal combustion engine (10) is retarded during the heating of the catalytic converter (28).

13. The system according to claim 6, wherein the internal combustion engine (10) is operated with a homogeneous fuel-air mixture and with a plurality of partial injections repeatedly per operating cycle into a combustion chamber (12) during the heating of the catalytic converter (28).

14. A computer program for execution on a controller (32) configured to operate an internal combustion engine (10) for a motor vehicle, said internal combustion engine (10) comprising an exhaust gas system (26) having at least one catalytic converter (28; 30) and at least one lambda probe (38; 40), wherein the internal combustion engine (10) is operated alternately with a lean and a rich fuel-air mixture after a cold start for heating the catalytic converter (28; 30), the computer program including instructions to perform the method of:
heating the lambda probe (40) after the cold start in such a way that it is ready for operation after at most 10 s; and
operating the internal combustion engine (10) with a two-level control based on a signal (U_{L}) from the lambda probe (40), such that the change between the operation with lean fuel-air mixture and the operation with rich fuel-air mixture is in each case initiated by the signal (U_{L}) from the lambda probe (40).

15. The computer program according to claim 14, wherein the computer program is in a machine-readable form.

16. The computer program according to claim 14, further comprising instructions for initiating the change based on the signal (U_{L}) from the lambda probe (40) which is arranged downstream of the catalytic converter (28).

17. The computer program according to claim 14, further comprising instructions for initiating the change based on the signal (U_{L}) from the lambda probe (38) which is arranged upstream of the catalytic converter (28).

18. The computer program according to claim 14, further comprising instructions for opening a throttle valve (44) of the internal combustion engine (10) wide during the heating of the catalytic converter (28), and retarding an ignition angle of the internal combustion engine (10).

19. The computer program according to claim 14, further comprising instructions for operating the internal combustion engine (10), during the heating of the catalytic converter (28), with a homogeneous fuel-air mixture and with a plurality of partial injections repeatedly per operating cycle into a combustion chamber (12) of the internal combustion engine (10).
